(19) United States
(12) Patent Application Publication
(10) Pub. No.: US 2017/0090093 A1
(43) Pub. Date: Mar. 30, 2017

(54) LIGHT SOURCE COMPONENTS AND BACKLIGHT MODULES

(71) Applicant: Wuhan China Star Optoelectronics Technology Co., Ltd., Wuhan, Hubei (CN)

(72) Inventors: Gege ZHOU, Shenzhen, Guangdong (CN); Shihhsiang CHEN, Shenzhen, Guangdong (CN)

(73) Assignee: Wuhan China Star Optoelectronics Technology Co., Ltd., Wuhan, Hubei (CN)

(21) Appl. No.: 14/778,244

(22) PCT Filed: Aug. 11, 2015
(86) PCT No.: PCT/CN2015/086667

§ 371 Date: Sep. 18, 2015

(30) Foreign Application Priority Data
May 7, 2015 (CN) 201510229479.0

(51) Int. Cl. F21V 8/00

(52) U.S. Cl. CPC G02B 6/0026; G02B 6/002; G02B 6/0088; G02B 6/0091

(57) ABSTRACT

A light source component includes a substrate, dot light sources being spaced apart on the substrate, two supports respectively fixed on two ends of the substrate, and a QD tube. The two supports are arranged close to the dot light sources. The QD tube is fixed between the supports. In addition, the backlight module includes the light source component is disclosed. In view of the above, the QD tubes are fixed between the two supports made by buffering materials, which prevents the QD tube from being damages due to crash or shock so as to enhance the product reliability. In addition, the prism structure or the attached prism film on the lateral side of the QD tube may enhance the brightness of the light beams entering the light guiding plate.

### BACKGROUND OF THE INVENTION

1. Field of the Invention

The present disclosure relates to liquid crystal display technology, and more particularly to a light source component and a backlight module.

2. Discussion of the Related Art

Currently, liquid crystal devices (LCDs) have been adopted as display panels in a variety of electronic devices. With the increasing demand toward color saturation, the color range of display panels of LCDs has to be as high as possible.

Generally, a conventional LCD includes a liquid crystal panel and a backlight module opposite to the liquid crystal panel. The backlight module, which is the most important component of LCDs, plays an important role with respect to the color range of LCDs. Usually, quantum dots (QD) may be adopted in backlight module so as to enhance the color range of the backlight module. For instance, the QD are encapsulated within a glass tube to form a QD tube. Light beams emitted from the light source of the backlight module pass through the QD tube to activate the QD so as to generate the display backlight having a high color range. However, as the QD tube is fragile, it is critical to prevent the QD tube from being fragmented when fixing the QD tube.

### SUMMARY

In one aspect, a light source component includes a substrate, dot light sources being spaced apart on the substrate, at least two supports being fixed on the substrate, and a QD tube. The supports are arranged close to the dot light sources, and the QD tube is fixed between the supports.

Wherein the two supports are respectively fixed on two ends of the substrate.

Wherein when the QD tube is fixed between the supports, a central axis of the QD tube is parallel to a line encompassing all of the dot light sources.

Wherein each of the supports includes a base, a first arm and a second arm extending upward from two ends of the base, a first hook extending from the first arm toward the second arm, and a second hook extending from the second arm to the first arm, and the base, the first arm, the second arm, the first hook, and the second hook cooperatively define a receiving chamber for receiving the QD tube.

Wherein the supports are made by rubber, plastic, or metallic sheets.

Wherein the QD tube comprises a glass tube and QDs within the glass tube.

Wherein a lateral surface of the glass tube facing away from the dot light sources comprises a prism structure.

Wherein a lateral surface of the glass tube facing away from the dot light sources is adhered with a prism film.

In another aspect, a backlight module includes the above light source component.

Yet in another aspect, a liquid crystal display includes the above backlight module.

In view of the above, the QD tubes are fixed between the two supports made by buffering materials, which prevents the QD tube from being damages due to crash or shock so as to enhance the product reliability. In addition, the prism structure or the attached prism film on the lateral side of the QD tube may enhance the brightness of the light beams entering the light guiding plate.

### BRIEF DESCRIPTION OF THE DRAWINGS

FIG. 1 is a side view of the LCD in accordance with one embodiment.

FIG. 2 is a partial side view of the backlight module in accordance with one embodiment.

FIG. 3 is a perspective view of the light source component in accordance with one embodiment.

FIG. 4 is a perspective view of the support in accordance with one embodiment.

FIG. 5 is a side cross-sectional view of the QD tube in accordance with one embodiment.

FIG. 6 is a side cross-sectional view of the QD tube in accordance with another embodiment.

FIG. 7 is a side cross-sectional view of the QD tube in accordance with another embodiment.

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may he omitted and/or functions described in unnecessary detail.

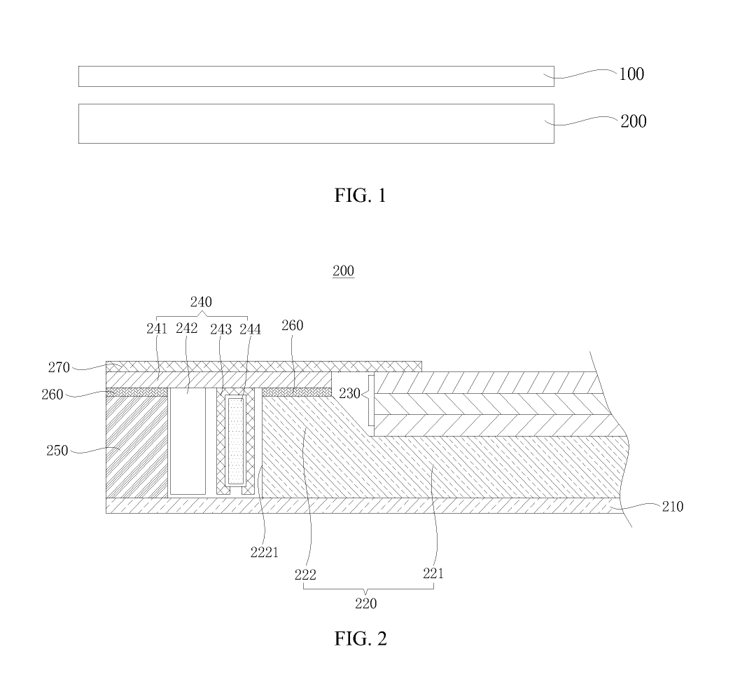

FIG. 1 is a side view of the LCD in accordance with one embodiment. The LCD includes a liquid crystal panel 100 and a backlight module 200. The backlight module 200 provides display backlight having a high color range to the liquid crystal panel 100 such that the liquid crystal panel 100 is capable of displaying images. In the embodiment, the concrete structure of the liquid crystal panel 100 may be referred to conventional LCD, and thus is omitted hereinafter.

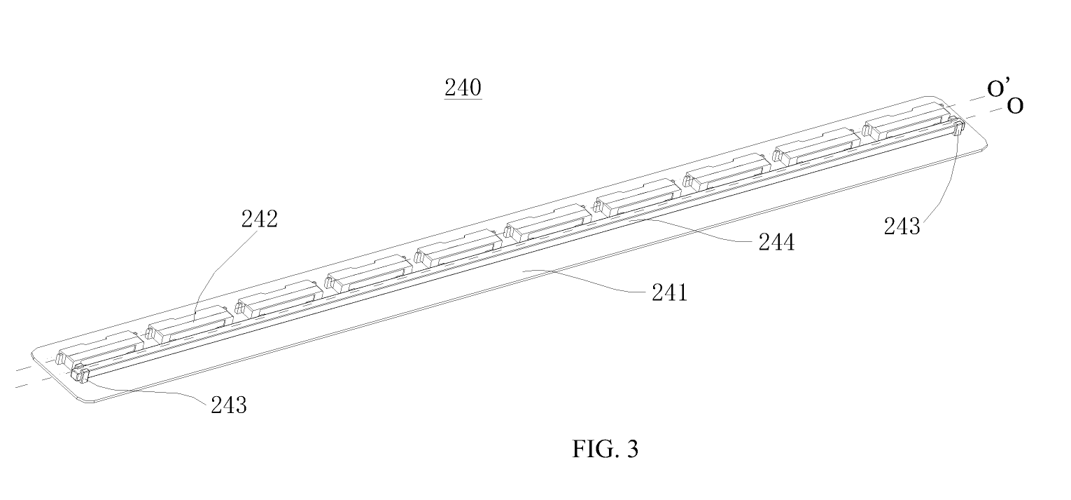

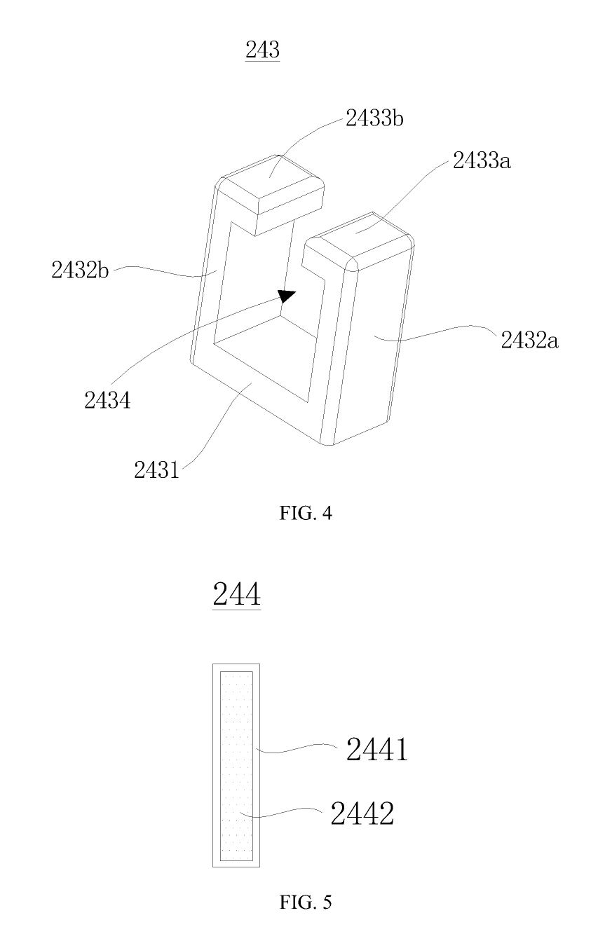

The backlight module 200 in the embodiment will be described hereinafter. FIG. 2 is a partial side view of the backlight module in accordance with one embodiment. FIG. 3 is a perspective view of the light source component in accordance with one embodiment. FIG. 4 is a perspective view of the support in accordance with one embodiment.

Referring to FIG. 2, the backlight module 200 includes a reflective sheet 210, a light guiding plate 220, a plurality of optical films 230, a light source component 240, and a plastic frame 250.

The light guiding plate 220 is arranged on the reflective sheet 210. In the embodiment, the light guiding plate 220 may be, but not limited to, a wedge-shaped light guiding plate. For instance, the light guiding plate 220 may be a sheet-shaped light guiding plate. The light guiding plate 220 includes a flat body 221 and a wedge body 222 extending upward along one end of the flat body 221. A thicker surface 2221 of the wedge body 222 is usually the light incident surface, and a thinner surface of the wedge body 222 connects with one end of the flat body 221 smoothly.

The plastic frame 250 is arranged on the reflective sheet 210, and the plastic frame 250 faces toward the thicker surface 2221.

Referring to FIG. 3, the light source component 240 includes a substrate 241, dot light sources 242 being spaced apart from each other on the substrate 241, two supports 243, and a QD tube 244. The two supports 243 are fixed on two ends of the QD tube 241. In addition, the two supports 243 are arranged close to the dot light sources 242, and the QD tube 244 is fixed between the two supports 243. It is to be noted that the number of the supports 243 may not be other than two, as shown in FIG. 3. For instance, the light source component 240 may include three or more than three supports 243. In this way, the light beams emitted from the dot light sources 242 pass through the QD tube 244, and the QDs within the QD tube 244 may be activated to generate light beams having the high color range.

In the embodiment, the QD tube 241 may be a printed circuit board (PCB). In addition, the two supports 243 may be respectively fixed on two ends of the QD tube 241. When the QD tube 244 is fixed between the two supports 243, a central axis (O) is parallel to the line (O′) encompassing all of the dot light sources 242. That is, a connecting line between the two supports 243 is parallel to the line (O′) encompassing all of the dot light sources 242.

Referring to FIG. 4, the supports 243 may include a base 2431, a first arm 2432a and a second arm 2432b extending upward from two ends of the base 2431, a first hook 2433a extending from the first arm 2432a toward the second arm 2432b, and a second hook 2433b extending from the second arm 2432b to the first arm 2432a. Further, there is a gap between the first hook 2433a and the second hook 2433b. The base 2431, the first arm 2432a, the second arm 2432b, the first hook 2433a, and the second hook 2433b cooperatively define a receiving chamber 2434 for receiving the QD tube 244.

In order to provide certain buffering capacity to the QD tube to prevent the QD tube from being damaged due to crash or shock, in the embodiment, the supports 243 may be made by, but not limited to, rubber, plastic or metallic sheets.

Referring to FIG. 2, when assembling the light source component 240, the QD tube 241 is arranged above the plastic frame 250 and the wedge body 222 of the light guiding plate 220. In addition, the QD tube 241 is fixed on the plastic frame 250 and the wedge body 222 via double-sided adhesive 260 such that the dot light sources 242 is arranged between the light incident surface 2221 and the plastic frame 250, and the QD tube 244 is arranged between the dot light sources 242 and the light incident surface 2221. In this way, the QDs within the QD tube 244 being activated may generate the light beams having the high color range, and the light beams may enter the light guiding plate 220 via the light incident surface 2221.

The optical films 230 are arranged on the flat body 221 of the light guiding plate 220 in sequence. In addition, the optical films 230 are fixed on the QD tube 241 via shading double-sided adhesive 270. In the embodiment, the optical films 230 may be a brightness enhancement film and a diffusor for enhancing optical quality of the light beams emitted from a top of the flat body 221. As shown in FIG. 2, three optical films 230 are shown, but it can be understood that the present disclosure is not limited to the above.

FIG. 5 is a side cross-sectional view of the QD tube in accordance with one embodiment. Referring to FIG. 5, the QD tube 244 includes a glass tube 2441 and QDs 2442 within the glass tube 2441.

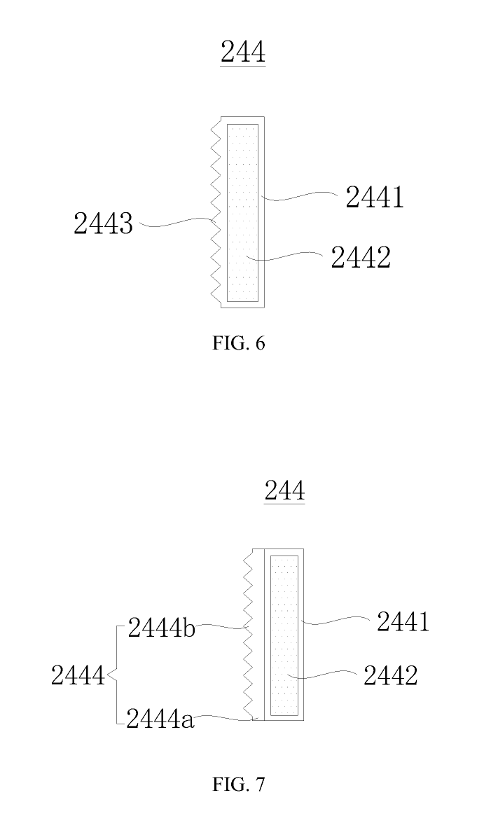

FIG. 6 is a side cross-sectional view of the QD tube in accordance with another embodiment. The difference between the QD tubes in FIGS. 5 and 6 resides in that the QD tube in FIG. 6 includes a prism structure 2443 formed on a lateral surface of the glass tube 2441, and the lateral surface faces away from the dot light sources 242. The cross-sections of the prism structure 2443 may be, but not limited to substantially triangle. In addition, the prism structure 2443 protrudes from the lateral surface of the glass tube 2441.

FIG. 7 is a side cross-sectional view of the QD tube in accordance with another embodiment. The QD tube of FIG. 7 is different from that in FIGS. 5 and 6 for the reason that a prism film 2444 is adhered to the lateral side of the glass tube 2441, and the lateral side faces away from the dot light sources 242. The prism film 2444 includes a base sheet 2444a and protrusions 2444b formed on the base sheet 2444a. The cross-sections of the protrusions 2444b may be, but not limited to, substantially triangle.

In view of the above, the QD tubes are fixed between the two supports made by buffering materials, which prevents the QD tube from being damages due to crash or shock so as to enhance the product reliability. In addition, the prism structure or the attached prism film on the lateral side of the QD tube may enhance the brightness of the light beams entering the light guiding plate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light source component, comprising:
a substrate, dot light sources being spaced apart on the substrate, two supports respectively fixed on two ends of the substrate, and a QD tube, the two supports being arranged close to the dot light sources, each of the supports comprising a base, a first arm and a second arm extending upward from two ends of the base, a first hook extending from the first arm toward the second arm, and a second hook extending from the second arm to the first arm, wherein the base, the first arm, the second arm, the first hook, and the second hook cooperatively defining a receiving chamber for receiving the QD tube.

2. The light source component as claimed in claim 1, wherein when the QD tube is fixed between the supports, a central axis of the QD tube is parallel to a line encompassing all of the dot light sources.

3. The light source component as claimed in claim 1, wherein the supports are made by rubber, plastic, or metallic sheets.

4. The light source component as claimed in claim 1, wherein the QD tube comprises a glass tube and QDs within the glass tube.

5. The light source component as claimed in claim 4, wherein a lateral surface of the glass tube facing away from the dot light sources comprises a prism structure or is adhered with a prism film.

6. A light source component, comprising:
a substrate, dot light sources being spaced apart on the substrate, at least two supports being fixed on the substrate, and a QD tube, the supports being arranged close to the dot light sources, and the QD tube being fixed between the supports.

7. The light source component as claimed in claim 6, wherein the two supports are respectively fixed on two ends of the substrate.

8. The light source component as claimed in claim 7, wherein when the QD tube is fixed between the supports, a central axis of the QD tube is parallel to a line encompassing all of the dot light sources.

9. The light source component as claimed in claim 6, wherein each of the supports comprises a base, a first arm and a second arm extending upward from two ends of the base, a first hook extending from the first arm toward the second arm, and a second hook extending from the second arm to the first arm, and the base, the first arm, the second arm, the first hook, and the second hook cooperatively define a receiving chamber for receiving the QD tube.

10. The light source component as claimed in claim 6, wherein the supports are made by rubber, plastic, or metallic sheets.

11. The light source component as claimed in claim 6, wherein the QD tube comprises a glass tube and QDs within the glass tube.

12. The light source component as claimed in claim 11, wherein a lateral surface of the glass tube facing away from the dot light sources comprises a prism structure or is adhered with a prism film.

13. A backlight module, comprising:
a light guiding plate and a light source component being arranged at a light incident surface of the light guiding plate, wherein the light source component comprising a substrate, dot light sources being spaced apart on the substrate, at least two supports being fixed on the substrate, and a QD tube, the supports being arranged close to the dot light sources, and the QD tube being fixed between the supports.

14. The light source component as claimed in claim 13, wherein the two supports are respectively fixed on two ends of the substrate.

15. The light source component as claimed in claim 14, wherein when the QD tube is fixed between the supports, a central axis of the QD tube is parallel to a line encompassing all of the dot light sources.

16. The light source component as claimed in claim 13, wherein each of the supports comprises a base, a first arm and a second arm extending upward from two ends of the base, a first hook extending from the first arm toward the second arm, and a second hook extending from the second arm to the first arm, and the base, the first arm, the second arm, the first hook, and the second hook cooperatively define a receiving chamber for receiving the QD tube.

17. The light source component as claimed in claim 13, wherein the supports are made by rubber, plastic, or metallic sheets.

18. The light source component as claimed in claim 13, wherein the QD tube comprises a glass tube and QDs within the glass tube.

19. The light source component as claimed in claim 18, wherein a lateral surface of the glass tube facing away from the dot light sources comprises a prism structure or is adhered with a prism film.
